(19) United States
(12) Patent Application Publication
(10) Pub. No.: US 2025/0052775 A1
(43) Pub. Date: Feb. 13, 2025

(54) APPARATUS AND PROCESS FOR SORTING CONTAINERS OF BIOLOGICAL SAMPLES IN AN AUTOMATION SYSTEM OF AN ANALYASIS LABORATORY

(71) Applicant: Inpeco SA, Novazzano (CH)

(72) Inventors: Enrico CAMUSSO, Novazzano (CH); Manuel GIOLO, Novazzano (CH)

(21) Appl. No.: 18/719,459

(22) PCT Filed: Dec. 14, 2022
(86) PCT No.: PCT/IB2022/062209

§ 371 Date: Jun. 13, 2024

(30) Foreign Application Priority Data
Dec. 16, 2021 (IT) 102021000031598

(51) Int. Cl. G01N 35/04; G01N 35/00

(52) U.S. Cl. CPC G01N 35/04; G01N 35/00732; G01N 2035/00801; G01N 2035/0406; G01N 2035/047; G01N 2035/0484

(57) ABSTRACT

An apparatus for sorting containers of biological samples for an automation system of an analysis laboratory includes a transport line having a conveyor belt on which are transported carriers arranged to receive and support a container. Parallel spaced apart sorting lines extend from the transport line. Each sorting line is associated with a diverter member transversely movable to the transport line from an inoperative backward position to an advanced position configured to divert a carrier from the transport to the sorting line. Each diverter member, when activated, has a first forward movement to a first position in a middle of the transport line, and a second forward movement to the advanced position, to push the intercepted carrier in the respective sorting line. When the diverter member intercepts a carrier, it is static in the middle of the transport line thereby not producing any cross collision with the intercepted carrier.

### FIELD OF THE INVENTION

The present invention refers to an apparatus for sorting containers of biological samples, for an automation system of an analysis laboratory, having the features indicated in the preamble of claim 1.

### PRIOR ART

Nowadays, in the context of automated systems which are widely used in analysis laboratories of biological samples, it is increasingly felt the need to ensure in every situation a correct routing of containers of biological material (typically test tubes) towards an ever-increasing variety of operating modules present in the laboratory, responsible for carrying out operations of various kinds on the sample itself, whether they are pre-analysis, post-analysis, or analysis on the content of the biological sample.

In this sense, test tubes of different destinations can travel for large distances along a common path of an automation system, but then it must be ensured the correct sorting of each carrier and of the container housed on it, towards the module responsible for performing, on each biological sample, every specific operation among those present in the workflow of the sample itself.

Routing systems are already known, for example from patent U.S. Pat. No. 3,796,544A, which from a common transport line provide for a diversion, orthogonal to the direction of the aforementioned transport line, of the carriers with the related containers along different lanes or accumulation areas, according to different treatment logics for each group of samples, for example for the connection with different sample processing or analysis modules.

However, a solution of this type implies the use of mechanical details which do not allow the diversion of transport devices along these lanes or accumulation areas, except in two distinct passages, that is first by blocking their transit along the common transport line on which they travel and by proceeding only after with the diversion along the respective lane.

Other known systems carry out an “on the fly” diversion of the carriers with the tubes associated to them, but only with reference to the diversion of one or more carriers from a main transport line to a single auxiliary transport line. The carriers to be diverted are recognized along the main transport line, for example by means of an antenna arranged in a fixed position under the conveyor belt and able to detect an RFID identification tag carried by each carrier. The diversion is performed by driving mechanical means for pushing the carrier. The detection of the carrier is performed in a region sufficiently spaced upstream of the diversion point, so as to ensure that the diversion mechanism has sufficient time to activate upon the actual arrival of the carrier to be diverted. An example of such known diverter systems is illustrated in the patent EP 2 780 724 B1 by the same Applicant.

However, this kind of solution gives problems, since a “one to one” matching between each detector device (for example an antenna) and the related diverter device is essential. That is, at different diversion points along a laboratory automation system there must always be a detector upstream of the diversion point, to manage the diversions that should or should not occur at each point.

This naturally leads to having to replicate, at each portion of the automation system where a diversion of samples is necessary, all the hardware components and the software operating logic, thus leading to an increase in costs.

Furthermore, the known systems are able to manage always and only a single type of carrier to be diverted.

Last but not least, the known systems used to divert the carriers can push them too hard, from one lane to another, causing problems of leakage of biological material (“spillage”) from the test tubes housed in the carriers, in cases in which these travel uncapped along the conveyor belt of the laboratory automation system.

An apparatus according to the preamble of claim 1 is known from document U.S. Pat. No. 4,798,095 A.

### OBJECT OF THE INVENTION

The object of the present invention is to create an apparatus for the selective sorting of biological samples towards a plurality of sorting lines in an analysis laboratory automation system, which ensures a correct and reliable diversion of samples towards the respective destination lines, without the need to stop the flow of samples and regardless of their frequency of arrival at the apparatus.

A further object is to provide, in view of such plurality of different sorting lines along which the biological samples must be diverted, and therefore in view of a plurality of possible final destinations for the biological samples, a single detector device upstream of the diversion area of biological samples.

Another object is to manage, by means of a single apparatus, different types of carriers carrying the test tubes containing biological samples.

Another object is to realize a compact and at the same time modular apparatus, which therefore can be adapted to possible reconfigurations with reference to the arrangement of the modules which are present in the analysis laboratory, for example their addition or removal.

Last but not least purpose is to ensure that the diversion operation takes place in such a way as to avoid any risk of leakage of biological material from the sorted test tubes, in case they travel uncapped along the automation system.

### SUMMARY OF THE INVENTION

In view of achieving one or more of the aforementioned objects, the invention relates to an apparatus according to claim 1.

In one embodiment, the diverter member of each diverter device has a front surface with a side wing protruding from the front wall, on a downstream side of the diverter member, with reference to the direction of movement of the transport line, in such a way that when the diverter member stops in the position in the middle of the transport line, said side wing acts as a stop wall to intercept a carrier in transit, while the front surface pushes the intercepted carrier in the respective sorting line during the second forward movement of the diverter member.

In the preferred embodiment, along the transport line, immediately upstream of each sorting line, a sensor is arranged which is able to detect the transit of the carriers, said electronic controller being configured to receive the signal of the transit of the carriers from said sensor and to activate the diverter member, associated with the sorting line to which each carrier is destined, with a predetermined delay with respect to the signal of the passage.

In one embodiment, said transport line includes, upstream of the sorting lines, and upstream of said detector device, a stop gate, which can be moved by means of an actuator between a closed condition of obstruction of the transport line, in which an accumulation of carriers forms against the stop gate, and an open condition, the actuator of said stop gate being controlled by an electronic controller in such a way as to intermittently open the stop gate, whereby downstream of the stop gate the transport line advances the carriers in the direction of the sorting lines in positions spaced apart from each other.

The invention also relates to the sorting process carried out by means of the above described apparatus.

### DETAILED DESCRIPTION OF A PREFERRED EMBODIMENT

Further features and advantages of the invention will emerge from the following description with reference to the accompanying drawings, provided purely by way of non-limiting example, in which:

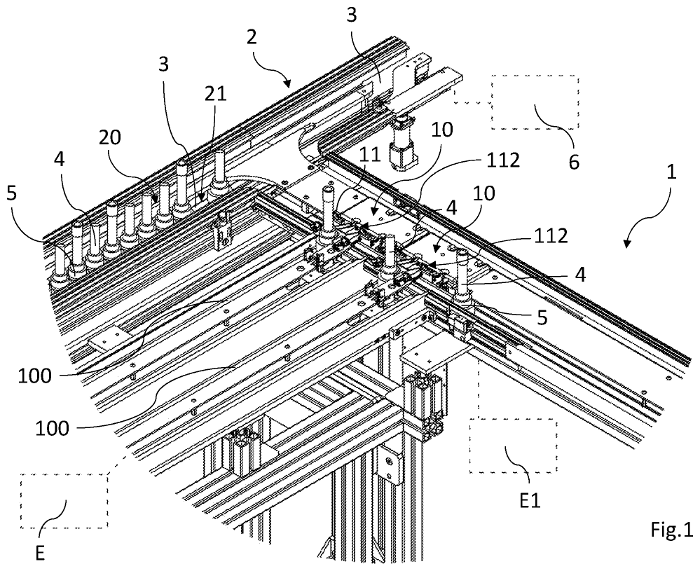

FIG. 1 is a perspective view of a preferred embodiment of the sorting apparatus according to the invention,

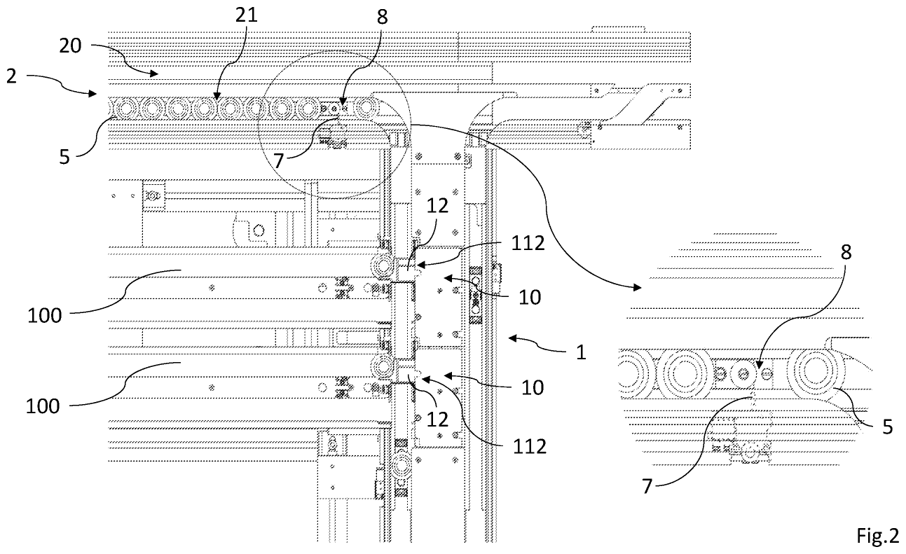

FIG. 2 shows an enlarged detail of an automation system according to the invention,

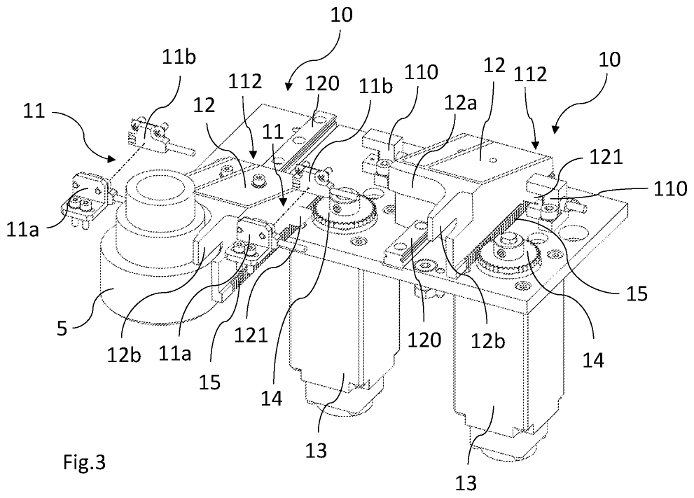

FIG. 3 represents a perspective view of a detail of the sorting apparatus of FIG. 1,

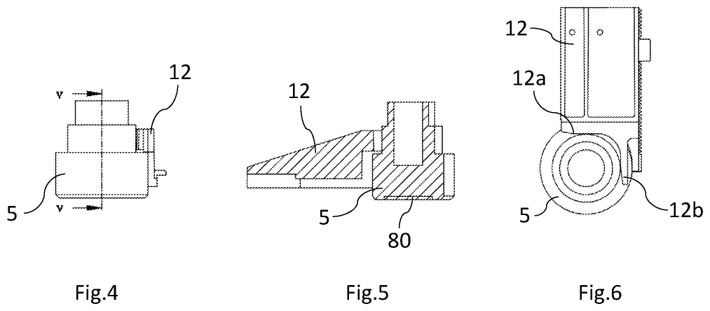

FIG. 4 shows in a front view a diverter according to the invention,

FIG. 5 is a rotated view of the diverter of FIG. 4, sectioned along the line V-V,

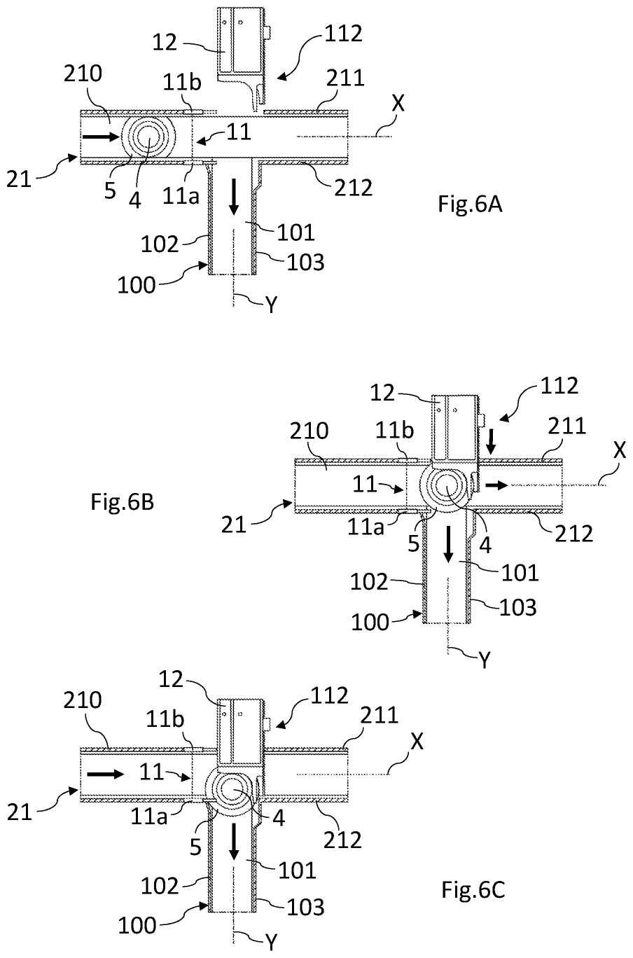

FIG. 6 is a top view of the diverter of FIG. 4, FIGS. 6A, 6B 6C show in a plan view three different operating positions of a diverter member,

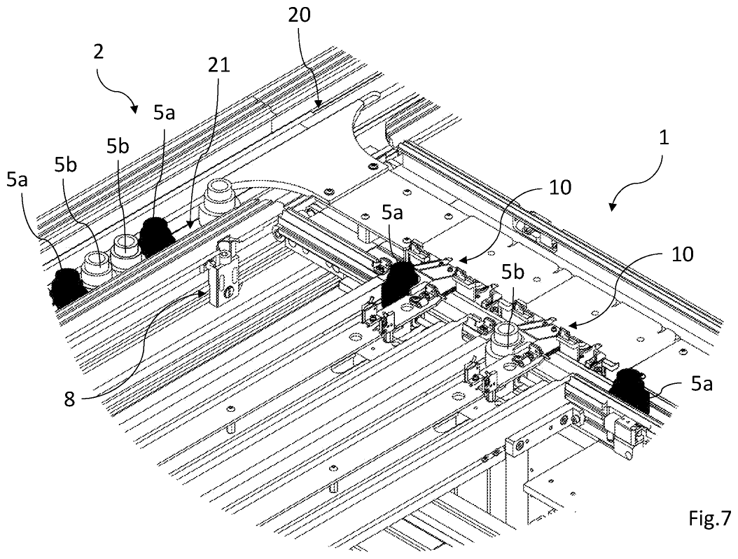

FIG. 7 is a perspective view of an alternative embodiment of the sorting apparatus according to the invention, and

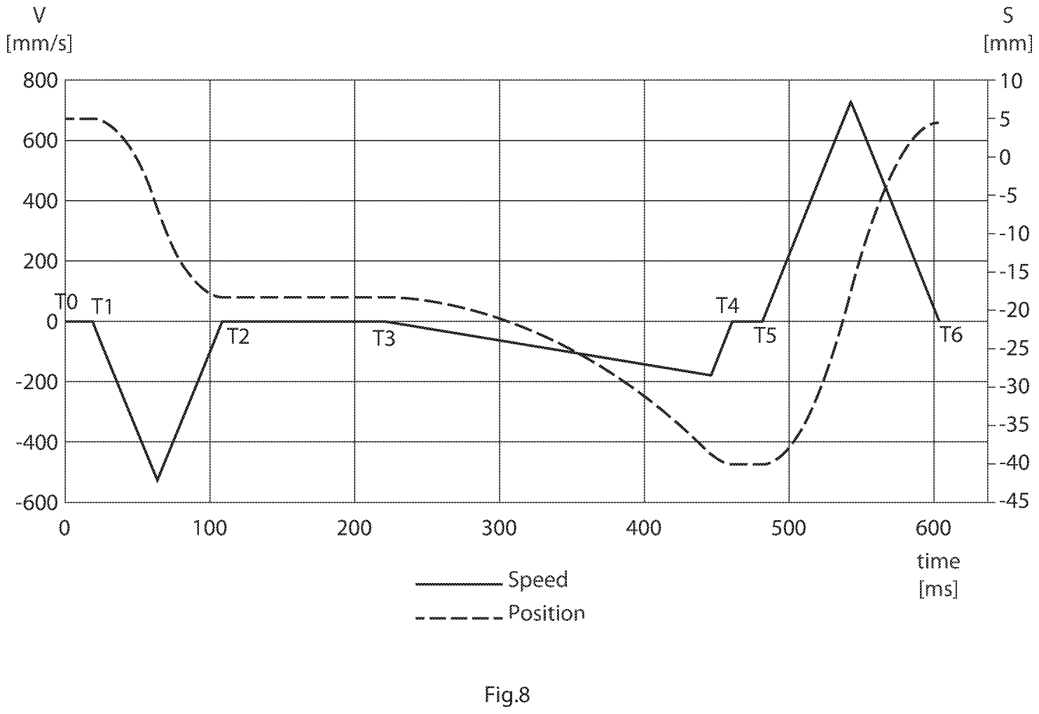

FIG. 8 is a diagram illustrating the variations over time of the position and speed of a diverter member during the diversion of a carrier in the respective sorting line, with reference to an embodiment.

In FIG. 1, which illustrates a preferred embodiment of the invention, the number 1 indicates as a whole an apparatus for sorting biological samples, used in an automation system 2 of an analysis laboratory.

Along such automation system 2 travel, on conveyor belts 3 substantially forming different routing lanes of biological samples, containers of biological material 4, advantageously test tubes, containing biological samples of different patients, which must be sent to a plurality of modules 6 (one of which is schematically illustrated in the form of a dashed block) of pre-analysis, analysis or post-analysis which interface with the automation system 2.

Each test tube 4 travels along the automation system 2 inserted in a carrier 5 of a suitable shape, in the example of circular shape, which is dragged by the conveyor belt 3 thus realizing the movement of the biological samples from one point to another of the automation system 2.

It is obvious that different test tubes 4, in relation to the various analyses to be eventually performed in succession on the biological sample contained therein, must undergo different processing and therefore different routing.

For this purpose, the laboratory automation system 2 advantageously comprises a main transport line 20 to manage the transfer of the biological samples from the module 6 to the following one. The main line 20 then branches out in correspondence with each of the modules 6 into a plurality of auxiliary lines along which to divert the biological samples which must be processed by a specific module 6.

The routing of the biological samples along the automation is managed by the electronic controller E of the automation system (schematically shown as a dashed block in FIG. 1). The electronic controller E knows at all times the position of each circulating carrier 5 with the respective test tube 4 and manages each routing thereof.

In a preferred embodiment, the carriers 5 are therefore diverted from the main line 20 to an auxiliary line (for example through a diversion mechanism similar to that described in the aforementioned patent EP 2 780 724 B1 by the Applicant) of the automation system 2, until they accumulate along it, being blocked by a stop gate 7 which protrudes from the section of the automation system 2 (see detail in FIG. 2) and advantageously detected at the same time by an antenna 8 in a position below the conveyor belt and able to carry out a detection of the carrier 5 by interfacing with an identifier 80 (for example an RFID tag) of to the latter (FIG. 5).

Specifically, the sorting apparatus 1 object of this invention is a particular embodiment of such module 6 along which to route a plurality of transport devices 5 with test tube 4 in view of the following selective routing of these transport devices 5 along the different paths downstream of the sorting apparatus 1. Such selective routing is preferably managed by an electronic controller E1 (schematically illustrated in FIG. 1) specific to the apparatus 1.

In particular, the sorting apparatus 1 comprises a transport line 21 having a first portion corresponding to the aforementioned auxiliary line along which the stop gate 7 and the related antenna 8 are arranged, and a second portion, preferably orthogonal to the first portion and connected to it by a 90° curve, interfaced to a plurality of sorting units 10, each of which in turn faces a sorting line 100 to which the diverted carrier devices 5 are directed downstream, each of these lines 100 representing therefore a specific routing path of biological samples, uniform among them for the processing which they must be subjected to or in any case generically for the routing they must undergo.

Each sorting unit 10 comprises an activation sensor 11 able to detect the passage of a carrier 5 and consequently to control a diverter device 112, comprising a diverter member 12 which routes the carrier 5 along the respective line 100. In the preferred embodiment, illustrated in detail in FIG. 3, the activation sensor 11 consists of an emitter 11a able to emit a signal which, depending on whether or not it is received by a receiver 11b, just allows to detect the passage of the carrier 5.

Each sorting unit 10 provides, downstream of the activation sensor 11, the diverter member 12 driven by an electric motor 13 which is controlled by the electronic controller E1 and which sets in rotation a pinion 14 which, engaging with a rack 15 integral with the diverter member 12, causes its movement in both directions, forward and backward, along a sliding track 120, in a direction perpendicular to the direction of the transport line 21.

The rest position, i.e. of complete retreat of the diverter member 12 is discriminated by the engagement of a flap 121 of the diverter member 12 with a presence sensor 110 positioned near the rear stroke end of the sliding track 120.

With reference again to FIGS. 6A, 6B, 6C, the transport line 21 of the apparatus according to the invention comprises a conveyor belt 210 on which are transported, in an aligned succession along a substantially horizontal transport direction X, a plurality of carriers 5 each arranged to receive and stably support a container (for example a test tube) for a biological sample. The transport line 21 comprises a guide lane for the carriers 5 transported on the conveyor belt 210 defined by two side walls 211, 212 which extend above and on both sides of the conveyor belt 210, between which the carriers 5 are guided. The sorting lines 100 are parallel to each other and spaced apart and extend from successive areas of the transport line 21, on one side of the transport line 21, in substantially horizontal directions and substantially orthogonal to the direction X of the transport line 21. Each sorting line 100 includes a conveyor belt 101 substantially coplanar with the conveyor belt 210 of the transport line 21 and orthogonal thereto. The conveyor belt 101 has an input end adjacent to an area of the transport line 21 at which the side wall 212 of the transport line 21, which is disposed on the side facing the sorting line 100, has a interruption, to allow the passage of the carriers 5 routed to the sorting line 100. Even each sorting line 100 comprises a guide lane defined by two walls 102, 103 extending above and on both sides of the conveyor belt 101.

With reference again to FIG. 6, the embodiment of the diverter member 12 which is illustrated therein has a front surface 12a with a lateral wing 12b which frontally protrudes from a downstream side of the front surface 12a (with reference to the direction of movement of the carrier 5 along the transport line 21). In this way, when the diverter member 12 advances through the transport line 21, the lateral wing 12b acts as a stop wall to intercept a carrier in transit (see FIG. 6B) while the front surface 12a pushes the intercepted carrier 5 towards the respective sorting line 100 (FIG. 6C).

The electronic controller E1 is configured to cause a forward movement of the diverter member 12, when the diverter member 12 is activated, which includes a first advance, from the backward position shown in FIG. 6A up to a first position, illustrated in FIG. 6B, in the middle of the transport line 21, wherein the diverter member 12 remains static for a not null time, to intercept an incoming carrier 5, without causing a collision against the carrier in the transversal direction. The movement of the diverter member 12 then continues with a second further forward movement up to the advanced position of FIG. 6C in which it pushes the intercepted carrier in the respective sorting line 100, with a speed that progressively increases, starting from zero.

In the following, a description will be provided concerning the use of the preferred embodiment of the apparatus 1 for sorting biological samples in an analysis laboratory, represented in FIGS. 1 to 6. However, this application is not to be intended in a limiting sense, since the device 1 can also be used for the selective sorting along a plurality of paths, for example different lanes, of other types of objects.

The sorting apparatus 1 receives biological samples circulating along the automation system 2. In particular, such biological samples contained in test tubes 4 which are in turn associated with a respective carrier 5 have been previously diverted from the main transport line 20 of the automation system 2 to the auxiliary line interfacing with the apparatus 1, according to the logic established by the electronic controller E of system 2.

The carriers 5, once diverted along the transport line 21, accumulate along it and are blocked at the stop gate 7 and from there detected through the antenna 8 arranged below the conveyor belt (FIG. 2), which communicates with the RFID tag 80 associated with each carrier 5.

This operation substantially confirms the successful passage of an expected carrier 5 with the related test tube 4, preparing the sorting apparatus 1 for the following management of each carrier. The electronic controller E of the automation system 2 in fact already has before the information related to the association between each carrier 5 and the related test tube 4 and consequently gives this information to the electronic controller E1 of the sorting apparatus 1 so that, when later each biological sample arrives thereto, it is suitably sorted along the expected path indicated by the electronic controller E.

Once the detection by the antenna 8 of the carrier 5 stopped at the stop gate 7 has been obtained, it is released and therefore proceeds towards the sorting apparatus 1.

As mentioned, the apparatus 1 comprises a plurality of sorting units 10 and naturally, due to the above-mentioned information exchanges, the apparatus 1 knows along which of the sorting lines 100, associated with each unit 10, the incoming carrier 5 must be diverted.

As soon as the carrier 5 crosses the first sorting unit 10 that it meets along the way, its passage is detected by the activation sensor 11.

If the carrier 5 must be diverted along the sorting line 100 associated with such unit 10, the electronic controller E1 controls the exit of the diverter member 12 (FIG. 3), which is positioned slightly downstream of the activation sensor 11, and carries out the diversion of the carrier 5 in the sorting line 100.

It is obvious that the electronic controller E1, through the appropriate setting of the distance between the activation sensor 11 and the diverter member 12 of each sorting unit 10, acts in such a way as to allow a diversion perfectly synchronized with the effective passage of the carrier 5 at the diverter member 12.

If, on the other hand, that specific carrier has to be processed by a following sorting unit 10, the electronic controller E1 naturally does not control the exit of the diverter, allowing the biological sample to pass to the following sorting unit 10, until it finds the one in charge of diverting it.

It should be noted that the action of the diverter member 12 on the carrier 5 substantially consists of an abutment action against its side surface, while it is passing, and of a subsequent accompanying movement along the sorting line 100 (FIGS. 6A, 6B, 6C): this double action avoids too sudden pushes which could lead, especially in the case of sorting of test tubes 4 which circulate uncapped along the automation system 2, to the leakage of the biological sample (“spillage”) during this operation.

In any case, the speed of action of each diverter member 12 should be pointed out since when it comes out to divert the carrier 5, its retreat must be almost immediate, given that the frequency with which the carriers 5 are released from the stop gate 7 and routed to the sorting apparatus 1 is very high and therefore it is possible that, in sequence, a new carrier 5 which must be routed to the next sorting unit 10 is immediately arriving and therefore its passage should not be hindered.

FIG. 8 of the annexed drawings shows the variations over time of the position s and the speed V of a diverter member 12 during the diversion of a carrier 5 in the respective sorting line, in case of a preferred embodiment.

In the diagram of FIG. 8, conventionally, the zero shift corresponds to a position advanced by 5 mm with respect to the rearmost position of the diverter member (see the y-axis on the right in the diagram). Furthermore, again by convention, the shifts of the diverter member starting from the zero position in the direction of the transport line have a negative sign. For the same reason, the speed is negative when the diverter member moves forward to divert a carrier and positive as the diverter member returns to its inoperative backward position.

As can be seen in the diagram of FIG. 8, at time T0 the diverter member 12 is in its inoperative backward position, where it remains static until time T1, waiting for the arrival of a carrier to be diverted. From time T1 to time T2, the diverter member advances up to the position in the middle of the transport line, accelerating and then slowing down until it stops in this position, where it remains static from time T2 to time T3 waiting that the carrier 5 to be diverted arrives against the lateral wing 12b of the diverter member 12 (see FIG. 6). In this way, when the carrier 5 arrives against the wing 12b, the diverter member 12 is static and therefore does not produce any lateral collision against the carrier which would cause instability for the container and a possible leakage of the content outside the container. From time T3 to time T4 the diverter member progressively increases its speed, with an acceleration in the order of 740-760 mm/s² (preferably 750 mm/s²) and then slows down again until it stops in the position of maximum advancement. From time T4 to time T5 the diverter member is static in the position of maximum advancement, and from time T5 to time T6 it returns to its inoperative backward position with a strong acceleration followed by a strong deceleration, so as to clear the transport line for the passage of other carriers.

As can be seen from the above description, the solution is highly modular, being able to provide any number of sorting units 10 constituting the apparatus 1, whilst always providing for a single upstream detection by a single antenna 8.

In an alternative embodiment, illustrated by way of example in FIG. 7, the management by a single sorting apparatus 1 of carriers 5a and 5b of different sizes, naturally to be routed to different lines 100 of different widths, can be provided, the apparatus itself in this case being eventually configured as an interface between different automation systems 2, placed side by side in a laboratory and just using different types of carriers 5a and 5b.

As evident from the preceding description, the apparatus according to the invention allows a precise sorting of transport devices with test tubes, diverting them as necessary towards a plurality of possible different downstream paths, in accordance with the routing logic of the whole automation system.

Moreover, with a single upstream detection of the transport devices by the antenna, a potentially infinite number of sorting units suitable for the above purpose can be controlled, according to a modularity principle which is particularly useful in case of changes to the spatial configuration of the modules in the laboratory (e.g. addition or removal of one of them).

An evident further advantage linked to the modularity of the apparatus is also, as it has been seen, the possibility of adapting it to the sorting of different types of transport devices, each transportable by different automation systems, the sorting apparatus acting in this case as real interface between different automation systems.

Furthermore, the push movement by each diverter on the carrier essentially acts in accompaniment, thus avoiding sudden pushes and any problem of leakage of biological material (“spillage”) from uncapped test tubes.

Studies and experiences conducted by the Applicant have shown that the use of an apparatus such as the one described above allows to considerably increase the productivity and efficiency of an analysis laboratory, since the carriers with test tubes can be conveyed towards one or more apparatuses arranged along an automation system, thus concentrating the sample sorting operations in a very compact space in a branched way and towards a multitude of paths and final destinations.

Naturally, without prejudice to the principle of the invention, the construction details and the embodiments may vary widely with respect to what is described and illustrated purely by way of example, without thereby departing from the scope of the present invention.

1. An apparatus for sorting containers of biological samples, for an automation system of an analysis laboratory, said apparatus comprising:
a transport line of containers of biological samples, including:
a plurality of carriers each arranged to receive and stably support a container for a biological sample,
a first conveyor belt on which said plurality of carriers are transported, in an aligned succession along a substantially horizontal transport direction, and
a first guide lane of the plurality of carriers transported on said first conveyor belt, defined by two side walls extending above and at two sides of the first conveyor belt, between which the plurality of carriers are guided,
a plurality of parallel sorting lines spaced apart from each other, extending from a succession of areas of said transport line, on a side of the transport line, in directions substantially horizontal and substantially orthogonal to the horizontal transport direction of said transport line,
each sorting line of the plurality of sorting lines including:
a second conveyor belt substantially coplanar with the first conveyor belt of said transport line and orthogonal thereto, having an inlet end adjacent to an area of said transport line at which a side wall of the two side walls of the transport line arranged on a side facing the sorting line has an interruption, for the passage of carriers of the plurality of carriers addressed to the sorting line,
a second guide lane of the sorting line, defined by another two side walls extending above and at two sides of the second conveyor belt of the sorting line, between which the carriers transported along the sorting line are guided,
a respective diverter device associated with each sorting line and arranged adjacent to said area of the transport line from which the sorting line starts, on the side opposite to said sorting line, said diverter device comprising a diverter member transversely movable to the transport line from an inoperative backward position to an advanced position in which it is able configured to divert a carrier of the plurality of carriers from the transport line to the sorting line, and an actuator of the movement of the diverter member,
said apparatus further comprising:
at least one detector device along said transport line, upstream of said sorting lines, configured to detect an information support carried by each carrier, and
an electronic controller configured and programmed to receive from said detector device an identifying information of each carrier and to consequently control the actuators of said diverter members, in such a way as to cause the diversion of each carrier towards a selected sorting line, to which the carrier is destined,
wherein:
said electronic controller is configured to control the actuators of said diverter members in such a way that each diverter member, when activated, has a forward movement which includes a first movement up to a first position in a middle of the transport line, wherein the diverter member remains static for a not null time, to intercept an upcoming carrier of the plurality of carriers, so as to avoid a cross collision with the intercepted carrier such as to induce an instability of the container carried by the intercepted carrier and a second further movement up to the advanced position, to push the intercepted carrier in the respective sorting line,
said transport line is configured to sufficiently space from each other the carriers in order to allow each diverter member to perform the first forward movement, to stop in said position in the middle of the transport line, to carry out the second forward movement, and then a return movement to its inoperative backward position, without interfering with the carrier that follows the intercepted carrier along the transport line.

2. The apparatus according to claim 1, wherein the diverter member of each diverter device has a front surface with a lateral wing protruding from a front wall, on a downstream side of the diverter member, with reference to a direction of movement of the transport line,
in such a way that when the diverter member stops in the position in the middle of the transport line, said lateral wing acts as a stop wall to intercept a carrier of the plurality of carriers in transit, while the front surface pushes the intercepted carrier in transit in the respective sorting line during the second forward movement of the diverter member.

3. The apparatus according to claim 1, wherein during said second forward movement, a speed of the diverter member progressively increases, with a constant acceleration in the order of 740-760 mm/s².

4. The apparatus according to claim 1, wherein along the transport line, immediately upstream of each sorting line, a sensor is arranged and configured to detect transit of plurality of carriers, said electronic controller being configured to receive a signal indicative of the passage of the plurality of carriers from said sensor and to activate the diverter member associated with the sorting line to which each carrier of the plurality of carriers is destined with a predetermined delay with respect to the signal indicative of the passage.

5. The apparatus according to claim 1, wherein said transport line includes, upstream of the sorting lines, and upstream of said detector device, a stop gate, movable by means of a stop gate actuator between a closed obstruction condition of the transport line, in which a stack of carriers is formed against the stop gate, and an open condition,
the actuator of said stop gate being controlled by the electronic controller in such a way as to intermittently open the stop gate, so that downstream of the stop gate the transport line advances the carriers towards the sorting lines in positions that are spaced apart from each other.

6. The apparatus according to claim 5, wherein said transport line is configured in such a way as to show a first portion of the transport line, along which said stop gate with said detector device is arranged, and a second portion of the transport line, orthogonal to the first portion and connected to it by a 90° curve, in such a way that the sorting lines extend parallel to said first portion of the transport line.

7. The apparatus according to claim 6, wherein said first portion of the transport line is an auxiliary line parallel to a main transport line of an automation system of an analysis laboratory.

8. A process for sorting containers of biological samples in an automation system of an analysis laboratory, said process comprising the steps of:
preparing a transport line of containers of biological samples, including:
a first conveyor belt on which are transported, in an aligned succession along a substantially horizontal transport direction, a plurality of carriers each arranged to receive and stably support a container for a biological sample, and
a guide lane of the plurality of carriers transported on said first conveyor belt, defined by two side walls extending above and at the two sides of the first conveyor belt, between which the plurality of carriers are guided,
said process further comprising the steps of:
arranging a plurality of parallel sorting lines spaced apart from each other, extending from a succession of areas of said transport line, on a side of the transport line, in directions substantially horizontal and substantially orthogonal to the horizontal transport direction of said transport line,
in which each sorting line of the plurality of sorting lines includes:
a second conveyor belt substantially coplanar with the first conveyor belt of said transport line and orthogonal thereto, having an inlet end adjacent to an area of said transport line at which a side wall of the two side walls of the transport line arranged on a side facing the sorting line has an interruption, for passage of carriers of the plurality of carriers addressed to the sorting line,
a guide lane of the sorting line, defined by another two side walls extending above and at two sides of the second conveyor belt of the sorting line, between which the carriers transported along the sorting line are guided,
a respective diverter device associated with each sorting line and arranged adjacent to said area of the transport line from which the sorting line starts, on a side opposite to said sorting line, said diverter device comprising a diverter member transversely movable to the transport line from an inoperative backward position to an advanced position in which it is configured to divert a carrier of the plurality of carriers from the transport line to the sorting line, and an actuator of the movement of the diverter member,
said process further comprising the steps of:
detecting, through at least one detector device, along said transport line, upstream of said sorting lines, an information support carried by each carrier, and
receiving in an electronic controller, from said detector device, an identifying information of each carrier and controlling, through said electronic controller, the actuators of said diverter members, in such a way as to cause the diversion of each carrier towards a selected sorting line, to which the carrier is destined,
wherein:
each diverter member, when activated, has a forward movement which includes a first movement up to a first position in a middle of the transport line, wherein the diverter member remains static for a not null time, to intercept an upcoming carrier of the plurality of carriers, so as to avoid a cross collision with the intercepted carrier such as to induce an instability of the container carried by the intercepted carrier and a second further movement up to the advanced position, to push the intercepted carrier in the respective sorting line,
the carriers transported on said transport line are sufficiently spaced from each other in order to allow each diverter member to perform the first forward movement, to stop in said position in the middle of the transport line, to carry out the second forward movement and then a return movement to its inoperative backward position, without interfering with the carrier that follows the intercepted carrier along the transport line.

9. The process according to claim 8, wherein the diverter member of each diverter device has a front surface with a lateral wing protruding from a front wall, on a downstream side of the diverter member, with reference to direction of movement of the transport line,
in such a way that when the diverter member stops in the position in the middle of the transport line, said lateral wing acts as a stop wall to intercept a carrier in transit, while the front surface pushes the intercepted carrier in transit in the respective sorting line during the second forward movement of the diverter member.

10. The process according to claim 8, wherein during said second forward movement, a speed of the diverter member progressively increases, with a constant acceleration in the order of 740-760 mm/s².
